(19) United States
(12) Patent Application Publication
(10) Pub. No.: US 2009/0007527 A1
(43) Pub. Date: Jan. 8, 2009

(54) Vehicle fuel supply device

(75) Inventor: Hideo Mitsudou, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA, Tokyo (JP)

(21) Appl. No.: 11/664,731

(22) PCT Filed: Jun. 14, 2005
(86) PCT No.: PCT/JP05/10874

§ 371 Date: Apr. 5, 2007

(51) Int. Cl. B01D 39/00

(52) U.S. Cl. 55/290; 55/385.3; 123/514

(57) ABSTRACT

A vehicle fuel supply device 1 according to the present invention includes a fuel pump 7 for sucking fuel 5 in a fuel tank 2 via a suction filter 12 and supplying the same to a fuel supply system of an internal combustion engine; a fuel holding chamber 102 for holding excessive fuel returned from the fuel supply system; a filter storage chamber 103 for storing the filter 12; and communicating means 105a, 105b and 105c for communicating the fuel holding chamber 102 and the filter storage chamber 103 and distributing the fuel held in the fuel holding chamber 102 to the filter storage chamber 103, and even when the fuel 5 in the fuel tank 2 is unevenly distributed due to a centrifugal force or the like and hence the vehicle fuel supply device 1 is not soaked in the fuel 5, the fuel held in the fuel holding chamber 102 is distributed to the filter storage chamber 103 by the communicating means 105a, 105b and 105c so that fuel can be supplied to the fuel supply system of the internal combustion engine without problem.

### TECHNICAL FIELD

The present invention relates to a vehicle fuel supply device for supplying fuel from a fuel tank provided on a vehicle such as a motorcycle to a fuel supply system for an internal combustion engine.

### BACKGROUND ART

In the case of a vehicle, in particular, a motorcycle, it is necessary to supply fuel to the fuel supply system by sucking fuel with a fuel pump reliably without being affected by a fuel level, which is varied according to acceleration or deceleration, or a change in posture of the vehicle when the amount of fuel remaining in the fuel tank is low. In the related art, as an example of a countermeasure therefor, there is provided a vehicle fuel supply device in which a cup opening on top is mounted to a bottom portion of the fuel tank, an opening having a diameter smaller than the inner diameter of the cup is formed on the fuel tank, and a main portion of the fuel pump and a fuel suction filter are inserted into the cup through the opening. According to this vehicle fuel supply device in the related art, even when the fuel level is varied due to the acceleration or deceleration, or the change in posture of the vehicle, an edge of the opening of the fuel tank restrains fuel staying in the cup from flowing into the fuel tank, so that the fuel pump can suck the fuel staying in the cup and supply the same to the fuel supply system (for example, see Patent Document 1).

There is also a device in which excessive fuel discharged from a pressure regulator that adjusts the pressure of fuel to be supplied to an injector in the related art is introduced into the proximity of the suction filter of the fuel pump via a return channel. However, a large number of air bubbles are contained in the excessive fuel. Therefore, when the fuel pump sucks the fuel in question, fuel supplied into an internal combustion engine is interrupted by the air bubbles, so that so-called breathing phenomenon of the internal combustion engine may be resulted. This phenomenon appears apparently particularly when it is used under a high-temperature environment such that fuel is liable to be boiled. Therefore, as an another device in which a countermeasure is devised therefor in the related art, a vehicle fuel supply device provided with a fuel adsorbing member composed of a sponge-like filter in the vicinity of a discharge port of the excessive fuel for separating fuel and the air bubbles so that the fuel pump is prevented from sucking the air bubbles is known (For example, see Patent Document 2).

Patent Document 1: JP-A-2000-72074 (pp. 4, left column from 28th to 39th lines)

Patent Document 2: JP-A-11-93794 (pp. 3, right column from 22nd to 34th lines)

### DISCLOSURE OF INVENTION

### Problems to be Solved by the Invention

In the vehicle fuel supply device in the related art shown in Patent Document 1, since there is provided the cup projected further from the bottom of the fuel tank, for example, the layout of the internal combustion engine or the like may be constrained. Since usage of the cup or the like is required, weight reduction of the device itself is hindered. On the other hand, when an attempt is made to accommodate variations in fuel level in the fuel tank without providing the cup, the fuel adsorption member as in the vehicle fuel supply device stated in Patent Document 2 is necessary as well as a device for storing fuel as a mater of course, which results in cost increase.

In order to solve the problems of the device in the related art as described above, it is an object of the present invention to obtain a vehicle fuel supply device that can follow the variations in the fuel level without the provision of the cup projected from the bottom of the fuel tank, and achieves air-fuel separation of the excessive fuel returned from the fuel supply system in a simple component structure whereby the fuel is supplied again to the fuel pump via the suction filter.

### Means for Solving the Invention

A vehicle fuel supply device according to the present invention includes: a fuel pump for sucking fuel in a fuel tank via a filter and supplying the same to a fuel supply system of an internal combustion engine; a fuel holding chamber for holding excessive fuel returned from the fuel supply system; a filter storage chamber for storing the filter; and communicating means for communicating the fuel holding chamber and the filter storage chamber and distributing the fuel held in the fuel holding chamber to the filter storage chamber.

### ADVANTAGES OF THE INVENTION

According to the vehicle fuel supply device in the present invention, since the excessive fuel returned from the fuel supply system is held in the fuel holding chamber and the fuel held in the fuel holding chamber is distributed to the filter storage chamber by the communicating means, even in a state in which the fuel pump cannot suck the fuel in the tank via the filter due to the change in posture of the vehicle or the like, fuel can be distributed from the fuel holding chamber to the filter storage chamber, and fuel can be supplied to the fuel supply system of the internal combustion engine without problem.

### BEST MODE FOR CARRYING OUT THE INVENTION

### Embodiment 1

FIG. 1 is a cross-sectional view of a vehicle fuel supply device (hereinafter, referred to as fuel supply device) according to Embodiment 1 of the present invention, showing a state of being installed in the interior of a fuel tank of a motorcycle as a vehicle.

In FIG. 1, a fuel supply device 1 according to Embodiment 1 of the present invention is fixed to an opening 22 provided on a bottom portion 21 of a fuel tank 2 of the motorcycle with bolts 51, 52 via a packing 3 and a mounting plate 4. Fuel 50 is stored in the fuel tank 2 to a position of a fuel level 501. A discharge pipe 6 is attached to the fuel supply device 1 and, as described later, the fuel in the fuel tank 2 sucked with a fuel pump via a “suction” filter (hereinafter referred simply as filter) 12 is supplied to a fuel supply system of an internal combustion engine, not shown, via the discharge pipe 6.

FIG. 2 is a cross-sectional view of the fuel supply device 1 according to Embodiment 1 of the present invention; FIG. 3 is a cross-sectional view taken along the line A-A in FIG. 2; and FIG. 4 is a cross-sectional view taken along the line B-B in FIG. 2.

In FIG. 2 to FIG. 4, the fuel supply device 1 is in a state in which the mounting plate 4 and the discharge pipe 6 are detachably attached as shown in FIG. 2 when it is not installed in the fuel tank 2. The fuel supply device 1 is fixed to the opening 22 of the bottom portion 21 of the fuel tank 2 with the bolts 51, 52 via the packing 3 as described above. A fuel pump 7 has a known structure, and is provided with an electric motor (not shown) and a vane wheel (not shown) rotated by being driven by the electric motor in the interior thereof, and sucks the fuel in the fuel tank from a suction member 71 by the rotation of the vane wheel via the filter 12 and discharges the fuel from the discharge member 72.

A case member 9 formed of resin is provided with a first hole 91, a second hole 92, a third hole 93 and a communication channel 94 for communicating these holes 91, 92, 93. The discharge member 72 of the fuel pump 7 is inserted into the first hole 91 of the case member 9 via an O-ring 8, and an opening portion of a fuel channel 101 provided in a chamber 100 formed of resin is inserted into the second hole 92 via an O-ring 10, and a known type of pressure regulator 11 provided with an diaphragm (not shown) therein is attached to the third hole 93 via an O-ring 111. The first hole 91, the communication channel 94, the second hole 92 and the pressure regulator 11 of the case member 9, and the fuel channel 101 of the chamber 100 constitute part of the fuel supply system of the internal combustion engine.

The fuel discharged from the discharge member 72 of the fuel pump 7 passes through part of the fuel supply system composed of the first hole 91, the communication channel 94 and the second hole 92 of the case 9, and the fuel channel 101 of the chamber 100, and is sent from the discharge pipe 6 further to the fuel supply system having an injector or the like of the internal combustion engine. The pressure regulator 11 is a member for adjusting the fuel pressure of the fuel supply system to a predetermined value as publicly known, which opens a valve (not shown) provided in the interior of the pressure regulator 11 by an action of the diaphragm when the fuel pressure in the fuel supply system is higher than the predetermined value and discharges the excessive fuel in the fuel supply system out of the pressure regulator 11 for adjusting the fuel pressure. The action to discharge the excessive fuel from the pressure regulator 11 is also referred to as to return the excessive fuel.

The resin made chamber 100 fixes the fuel pump 7. The chamber 100 is provided with a fuel holding chamber 102 having a shape to surround the outer peripheral portion of the fuel pump 7 as shown in FIG. 4. The chamber 100 is further provided with a filter storage chamber 103 that communicates with the suction member 71 of the fuel pump 7, and stores the filter 12 that is fitted to the suction member 71 of the fuel pump 7 in the filter storage chamber 103 in an oil-tight manner therein. The filter storage chamber 103 is opened on the bottom, and is filled with the fuel 50 in the fuel tank 2 in a state of being installed in the fuel tank 2. The filter 12 is composed of a known non-woven fabric or a nylon net member and removes impurities contained in fuel so that the fuel pump 7 does not suck these impurities.

The fuel holding chamber 102 and the filter storage chamber 103 are partitioned by a partitioning wall 104. The partitioning wall 104 is formed with slits 105a, 105b, 105c as communicating means for communicating the fuel holding chamber 102 and the filter storage chamber 103. The respective slits 105a, 105b, 105c are formed into an arcuate shape, and the width thereof is about 0.5 [mm]. As described later, air bubbles contained in the fuel held in the fuel holding chamber 102 is prevented from moving into the filter storage chamber 103 by these slits 105a, 105b, 105c. The air bubbles contained in fuel can be removed when the widths of the respective slits 105a, 105b, 105c are in the range of 0.3 [mm] to 0.7 [mm], and hence they may be any value as long as they fall within this range.

The fuel holding chamber 102 extends upwardly of FIG. 2 from the partitioning wall 104 along the peripheral surface of the fuel pump 7 and is opened at an upper end of the fuel pump 7. Therefore, the excessive fuel returned from the fuel supply system by a pressure regulating operation of the pressure regulator 11 is stored and held in the fuel holding chamber 102. Since the fuel holding chamber 102 is opened at the upper end thereof, the fuel 50 in the fuel tank 2 enters into the fuel holding chamber 102 and held therein in a state of being installed in the fuel tank 2.

The fuel supply device according to Embodiment 1 of the present invention configured as described above is fixed to the opening 22 provided on the bottom portion 21 of the fuel tank 2 and, in a normal state in which the vehicle is not inclined, or a large centrifugal force is not applied to the vehicle, is soaked in the fuel 50 in the fuel tank 2.

In this state, when the fuel pump 7 is driven, the fuel in the fuel tank is sucked into the fuel pump 7 from the suction member 71 via the filter 12 by the rotation of the vane wheel thereof, and is discharged from the discharge member 72. The fuel discharged from the discharge member 72 passes through the communication channel 94 of the case member 9, the fuel channel 101 of the chamber 100 and the discharge pipe 6 and is supplied to the fuel supply system of the internal combustion engine.

The fuel holding chamber 102 of the chamber 100 is filled with fuel returned from the pressure regulator 11 by the pressure adjusting operation of the pressure regulator 11 and the fuel 50 from the inside of the fuel tank 2. However, in the normal state in which the fuel supply device 1 is soaked into the fuel 50 as shown in FIG. 1, most part of the fuel sucked by the fuel pump 7 is sucked from the inside of the fuel tank 2 into the filter storage chamber 103 via the opened part at the lower portion of the filter storage chamber 103.

However, in the case of the vehicle, in particular, the motorcycle, there is a case in which a vehicle body is significantly inclined during the operation thereof, and the fuel 50 in the fuel tank 2 is adhered to a side wall of the fuel tank 2 as shown in FIG. 5, for example, by a centrifugal force exerted when traveling along a curve, and hence the fuel supply device 1 is exposed from the fuel 50. In this case, since the fuel 50 does not exist on the bottom portion 21 of the fuel tank 2, there is no supply of fuel into the filter storage chamber 103 from the opened part formed at the lower portion thereof. However, the fuel returned from the pressure regulator 11 is held in the fuel holding chamber 102 provided in the chamber 100 as described above, and the fuel held in the fuel holding chamber 102 drops into the filter storage chamber 103 via the slits 105a, 105b, 105c provided on the partitioning wall 104. Therefore, even when the fuel supply device 1 is exposed from the fuel 50 as shown in FIG. 5, the fuel pump 7 can suck the fuel supplied from the fuel holding chamber 102 into the filter storage chamber 103 via the filter 12, and hence it will not be an obstacle for the operation of the internal combustion engine.

Although the returned fuel from the pressure regulator 11 held in the fuel holding chamber 102 contains a number of air bubbles, most of the air bubbles cannot pass through the slits 105a, 105b, 105c when the fuel drops into the filter storage chamber 103 through the slits 105a, 105b 105c of a minute width and hence remain in the fuel holding chamber 102. Therefore, the fuel pump 7 can suck the fuel with a small number of air bubbles contained therein via the filter 12 and a defective discharge of the fuel pump as a result of having sucked the air bubbles and the breathing phenomenon of the internal combustion engine on the basis thereof can be prevented.

In the normal state in which at least the lower portion of the fuel supply device 1 is soaked into the fuel, the fuel sucked by the fuel pump 7 is supplied from the opened part at the lower portion of the filter storage chamber 103, and hence it is not necessary to increase the capacity of the fuel holding chamber 102, and the chamber 100 can be downsized.

### Embodiment 2

FIG. 6 is a cross-sectional view of the fuel supply device according to Embodiment 2 of the present invention; and FIG. 7 is a cross-sectional view taken along the line C-C therein.

In Embodiment 2, the chamber 100 is provided with vapor exhaust channels 106a, 106b, 106c that communicate with the filter storage chamber 103. The vapor exhaust channels 106a, 106b, 106c extend from the filter storage chamber 103 upward as shown in FIG. 6 and are opened at an upper end thereof.

The surface of the partitioning wall 104 exposed in the filter storage chamber 103 is formed into a tapered shape inclined upward in FIG. 6 from a center that the inlet pipe 71 of the fuel pump 7 passes through toward the peripheral edge. A peripheral edge 104a of the partitioning wall 104 is connected to the respective vapor exhaust channels 106a, 106b and 106c smoothly. Therefore, the air bubbles mixed in the fuel in the filter storage chamber 103 are conducted upward in FIG. 6 along the tapered surface of the partitioning wall 104, are moved into the vapor exhaust channels 106a, 106b, 106c, and are exhausted from the opening upwardly thereof.

Other configurations are the same as the first embodiment 1.

When the low-boiling fuel is used, the fuel may be boiled under a high-temperature environment, and hence a large number of air bubbles may be generated. When the air bubbles are generated in the vicinity of the filter 12, the fuel pump 7 sucks the air bubbles unless there is a way out for the air-bubble, and a defective fuel discharge may be resulted. However, according to the fuel supply device in Embodiment 2, even when the air bubbles are contained in the fuel in the filter storage chamber 103, these air babbles are guided upward in FIG. 6 by the tapered surface of the partitioning wall 104, and is exhausted through the respective vapor exhaust channels 106a, 106b, 106c to the outside of the fuel supply device 1. Therefore, even when the air bubbles are contained in the fuel, the air bubbles can be exhausted reliably out of the fuel supply device, whereby disadvantages such as the defective fuel discharge of the fuel pump or the breathing phenomenon of the internal combustion engine on the basis thereof can be prevented.

In Embodiment 1 and Embodiment 2, the communicating means provided on the partitioning wall 104 are slits. However, it is not limited to the slits, and a plurality of holes having diameters within the range from 0.3 [mm] to 0.7 [mm] in diameter may be employed.

### INDUSTRIAL APPLICABILITY

The vehicle fuel supply device according to the present invention can be utilized in a field of fuel supply device that supplies fuel to a fuel supply system of an internal combustion engine of a vehicle such as a motorcycle.

### BRIEF DESCRIPTION OF THE DRAWINGS

FIG. 1 is a cross-sectional view of a vehicle fuel supply device according to Embodiment 1 of the present invention, showing a state of being installed in the interior of a fuel tank.

FIG. 2 is a cross-sectional view of the vehicle fuel supply device according to Embodiment 1 of the present invention.

FIG. 3 is a cross-sectional view taken along the line A-A in FIG. 2.

FIG. 4 is a cross-sectional view taken along the line B-B in FIG. 2.

FIG. 5 is a cross-sectional view of the vehicle fuel supply device for explaining an operation of the vehicle fuel supply device according to Embodiment 1 of the present invention.

FIG. 6 is a cross-sectional view of the vehicle fuel supply device according to Embodiment 2 of the present invention.

FIG. 7 is a cross-sectional view taken along the line C-C in FIG. 6.

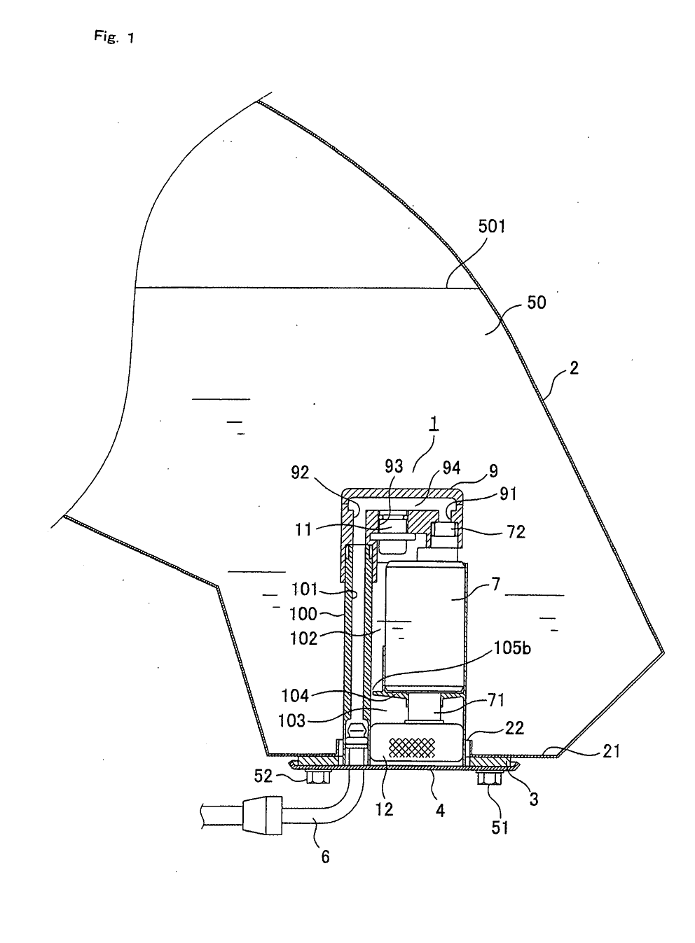

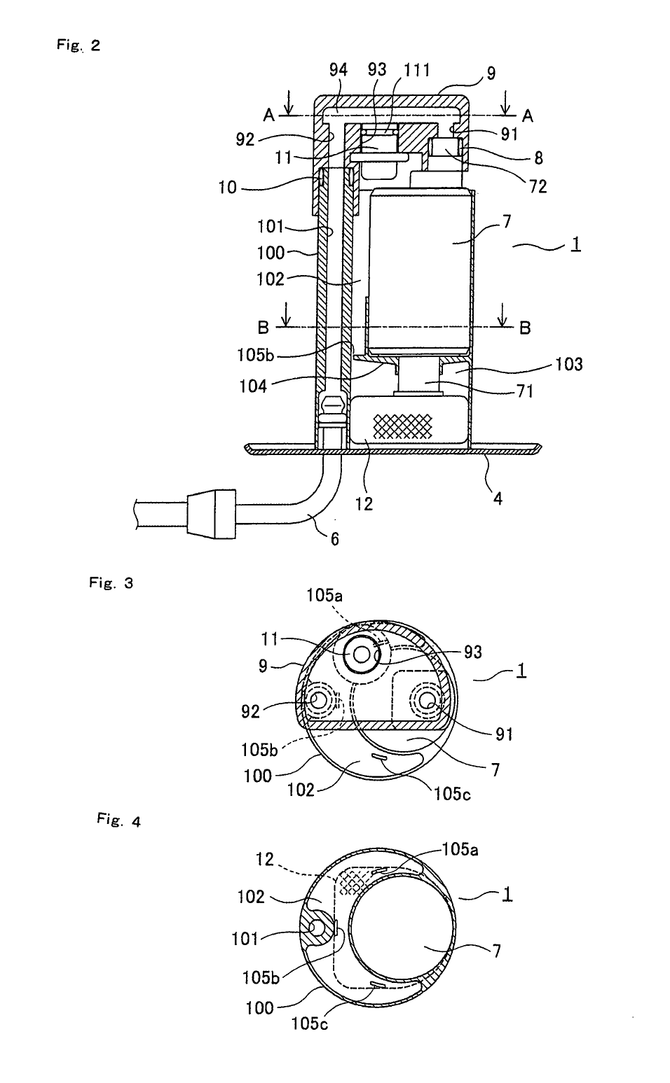

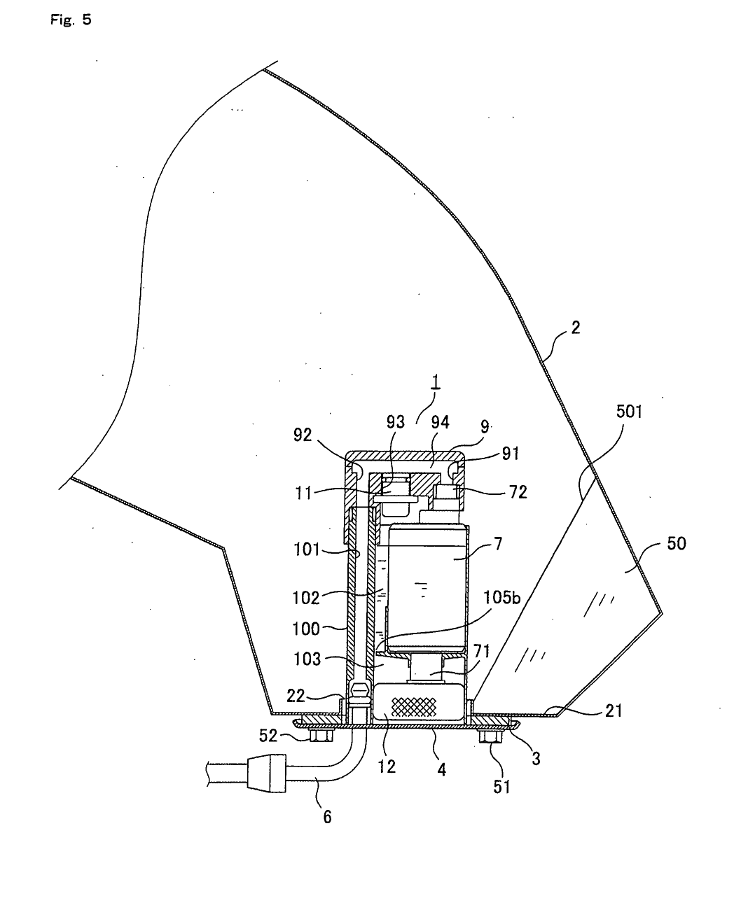

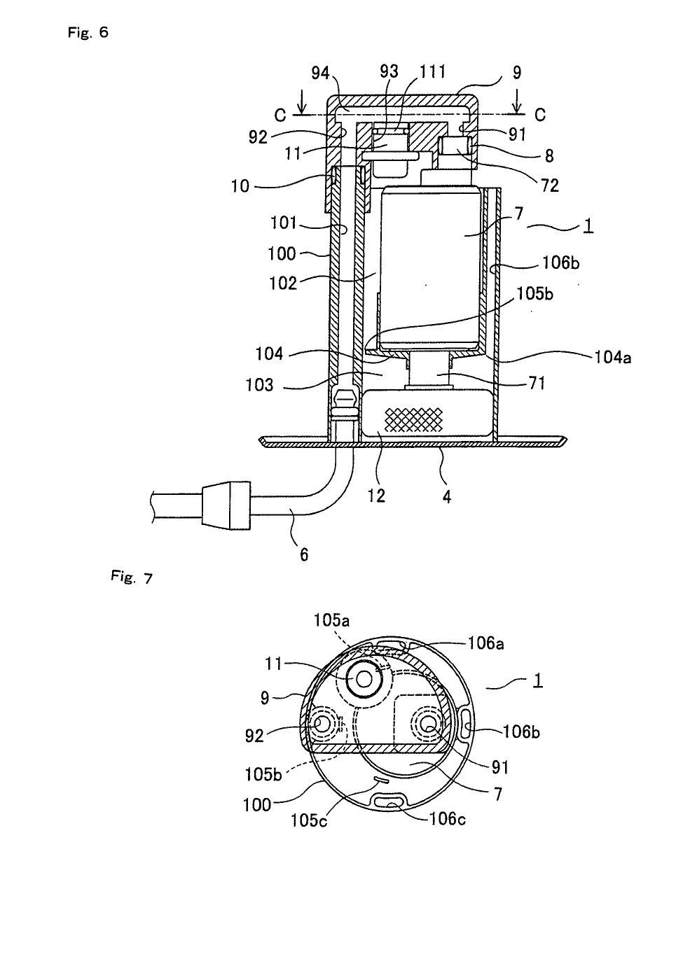

### DESCRIPTION OF THE REFERENCE NUMERALS

1 vehicle fuel supply device
2 fuel tank
3 packing
4 mounting plate
50 fuel
501 fuel level
6 discharge pipe
7 fuel pump
71 suction member
72 discharge member
8, 10, 111 O-ring
9 case member
91 first hole
92 second hole
93 third hole
94 communication channel
100 chamber
101 fuel channel
102 fuel holding chamber
103 filter storage
104 partitioning wall
105a, 105b, 105c slit
106a, 106b, 106c vapor exhaust channel

1. A vehicle fuel supply device comprising:
a fuel pump for sucking fuel in a fuel tank via a filter and supplying the same to a fuel supply system of an internal combustion engine;
a fuel holding chamber for holding excessive fuel returned from the fuel supply system;
a filter storage chamber for storing the filter; and
communicating means for communicating the fuel holding chamber and the filter storage chamber and distributing the fuel held in the fuel holding chamber to the filter storage chamber.

2. The vehicle fuel supply device according to claim 1, wherein the communicating means is composed of slits provided on a partitioning wall for partitioning between the fuel holding chamber and the filter storage chamber.

3. The vehicle fuel supply device according to claim 2, wherein the slits have widths that do not allow at least part of air babbles contained in the fuel held in the fuel holding chamber to pass into the filter storage chamber.

4. The vehicle fuel supply device according to claim 1, comprising a vapor exhaust path for exhausting the air babbles contained in the fuel in the filter storage chamber out of the filter storage chamber.

5. The vehicle fuel supply device according to claim 4, wherein the partitioning wall has a tapered portion for guiding the air bubbles contained in the fuel in the filter storage chamber to the vapor exhaust path.
